(19) United States
(12) Patent Application Publication
(10) Pub. No.: US 2019/0311651 A1
(43) Pub. Date: Oct. 10, 2019

(54) Context Responsive Communication Device and Translator

(71) Applicant: Re-Voice, Corporation, Allen, TX (US)

(72) Inventor: Eric Reed Marascio, Allen, TX (US)

(73) Assignee: Re-Voice, Corporation, Allen, TX (US)

(21) Appl. No.: 15/610,613

(22) Filed: May 31, 2017

Related U.S. Application Data
(60) Provisional application No. 62/368,727, filed on Jul. 29, 2016.

(51) Int. Cl. G09B 21/00; G10L 13/00; G06F 3/01; G06Q 20/12

(52) U.S. Cl. CPC G09B 21/009; G06Q 20/12; G06F 3/014; G10L 13/00

(57) ABSTRACT

A device for converting sign language to audible words, including one or more gesture recognition gloves having one or more sensors disposed about the fingers of the one or more gesture recognition gloves for detecting finger positions of sign language of a wearer of the one or more gesture recognition gloves; a processor for converting the detected sign language to the audible words; a memory unit for storing a library of the sign languages in communication with the processor; a power unit for powering the device; and a speaker for sounding the audible words.

### CROSS-REFERENCE TO RELATED APPLICATIONS

This application claims the benefit of U.S. Provisional Patent Application No. 62/368,727, filed Jul. 29, 2016. The entirety of this aforementioned application is incorporated herein by reference.

### TECHNICAL FIELD OF THE INVENTION

This invention relates, in general, to methods and apparatus for providing translation, and more particularly to methods and apparatus for providing context responsive communication.

### BACKGROUND OF THE INVENTION

Without limiting the scope of the present invention, its background will be described in relation to methods and apparatus for providing context responsive translation, as an example.

Despite the increasing variety and availability of communication and translating devices, it can be difficult to convey a message within context. Context provides meaning to the original communication, and without it, a translation may be incorrect or misinterpreted.

The background description provided herein is for the purpose of generally presenting the context of the disclosure. Today's job market is difficult for most people seeking employment. No industry is immune from the effects of economic flux. Availability is up one moth and down the next. Gains at the beginning of the year vanish at the year's end. It's a competitive dog-eat-dog market. Job seekers are hard pressed by industries that have the luxury of picking from a growing pool of candidates' skills, education and experience—these are in demand even for positions below a candidate's skill level. And still the unemployed compete hungrily for a placement that's beneath their capability.

For job-seekers who lack some specific skill, some basic utility, they are sure to be skipped. For them no potential is considered when compared to the vast pool of capably enabled with no evidence of disability. In a world built around communication what chance does the voice and hearing impaired have against the “standard” of hearing, speaking sound-enabled?

How many sales positions will not include a dynamic and enthusiastic personality, a real ‘go-getter,’ because they depend on sign-language to communicate? How about a waitress or bartender that has no idea how to communicate today's special without hand-speak? Face it, the truth is obvious. Jobs are vital for establishing our independence, our dreams. Good jobs are what we all shoot for. How many of us can say our career dream is to be the best busboy, dishwasher or maid's assistance we can be? What kind of career is minimum wage? Yet this is a reality for many speech and hearing impaired people. Communication, real-time, in the moment, familiar, comfortable, casual, common-communication is at the core of our lives and our ability to be independent.

What if the table was turned? What if you, Mister John Q. Citizen; or you, Ms. Jane Doe, woke up this morning and discovered ‘you’ were the one unable to communicate to your wife, husband, children, boss, or your parents. Not without a pad of paper and a pencil. Not without typing on a tablet to produce some computerized canned-voice speaking in hacked and sterile processed words that are more comical than effective. What if that was you? Who are you in that moment? How do you do what you need to do in any given situation when it requires communicating to someone who doesn't understand you? You are no longer a part of a sound-saturated population. You are an outsider. You rely on a translator to fill the void between you and the world around you. Someone who speaks to speak for you. Why? Because you cannot. It's as simple as that.

The present invention is redefining careers for millions of hearing impaired people. Look at it this way, growing and living deaf is not just a challenge, for most of us we can't truly imagine it. Sure we think it's no big deal not hearing—until we have to do it. And even then, having heard—losing your hearing is not the same as never heard at all. In the former case you at least have a frame of reference. You can add the memory of sound to events and share at least an idea of the modal experience of hearing through recollection. So there are degrees of dealing with, or coping with the absence of sound.

It's that coping with sound, the working around the situation and developing ways to accomplish tasks and interface with others, overcoming “their” ability to hear and inability to relate to the absence of it. It's the ability to push forward and carry on regardless of the obstacles the circumstance invents. It's the personality that adjust, embracing the day with fearless persistence, knowing what has to be done and able to do it. It's the capability to smile, to be friendly and accepting because their life has been constructed in such a way that they aren't derailed by the struggle to communicate, or the inability of others to understand them. These ‘handicapped’ deaf individuals are true survivors. They are persistent, enthusiastic, willing to look past our tendency to misunderstand them, to dismiss them, to ignore them.

They learn everyday of their lives. They read everything, everyone and everywhere. They know “dismissed” when they see it. They know when they are being sidelined. They know. And they bounce back. They use that rejection to catapult themselves forward over and over again. They are the epitome of “water-on-a-duck's-back.”

In the right situation a person like this would be invaluable as an employee. The goal-oriented salesperson who knows how to read the signs and close the deal. The customer liaison who knows how to relate to and sympathize with a frustrated consumer. A smiling hostess and a friendly bartender whose good mood and uplifting personality is based on certitude of life experience marked by numerous personal accomplishments. An entrepreneur with ideas, dreams, ambitions and the discipline of persistence and a confidence engineered from knocking down road blocks.

Put on the shoes of a lawyer in the process of arguing a case; a phone support tech helping solve a computer problem; a business owner instructing an employee in some task; a travel agent, a doctor, a police officer—each of them once “handicapped.” Now, with the present invention, they are handicapable.

### SUMMARY OF THE INVENTION

The present invention seeks to improve communication abilities to those who must communicate via sign language. The present invention eliminates this whole issue. It provides independence, fluidity, real-time relationships, and communication with emotion and real voice. It enables and empowers communication across barriers and across nationalities. There are no language limitations with the present invention. Each voice is unique to the individual, not some comical computerized audio. The present invention provides more than just a voice-it provides opportunity without limits.

The present invention delivers the tools to redefine circumstances, giving individuals the ability to communicate, person to person, and person to groups, and more. Add in the everyday functions we take for granted—talking on the phone. The present invention enables communication with a real-time vibrant and personal voice unique to the individual. And because it's real-time interaction, the user is able to engage in deep, meaningful conversation, discussions, and debates means more than you can imagine.

Communication, however, is about more than talking. Sometimes it's about enjoying music or dancing. Users of the present invention may also have the ability to experience music. The ability to feel the drive of a beat, experience the flight of harmony, the thrill of notes, and the complex sound sculpture of a song. Users can enjoy music as an experience that captures the senses. What's more, they can participate. They can share the experience with other users. Once they have familiarized themselves with present invention they'll discover their own voice, their own song and the ability to create their own music, music that embraces their senses and expresses their passion and creativity in a way totally unique to users. And they will be able to share it.

The present invention will empower the strength, the passion and the creativity unique to users. And these liberated individuals will become a force to be reckoned with. Those individuals do more than redefine existing industries; they will invent new expressions, new pathways, and new frontiers. They will be uncaged and unhindered. No longer held to the label “handicapped.” They will be right beside “normal” people. They will be lawyers, doctors, musicians, actors, dancers, athletes and professionals.

The present invention will provide the leverage for the voiceless and hearing impaired to claim a new destiny, one not labeled by “deaf” or “disabled” or “handicapped.” No more labels but one—“exceptionally enabled.” The present invention provides apparatus and methods for conveying a communication's context and translating a communication based, at least in part, on the context.

The context refers to the circumstances surrounding a communication. The context can include, but is not limited to, the location, the occurrence of a particular event the emotional state of a participant or the attendance of a specific participant. The context can also include specific details of the speaker or other participants. Specific detail can include, but is not limited to, physical details such as gender, weight, relationship status or nationality.

The communication device of preferred embodiments, includes a context device for identifying the context. The communication device of preferred embodiments, includes a context responsive translator t at provides a context dependent translation. The context dependent translation is a translation that is dependent, at least in part, on the context. According to an embodiment, the communication device includes a context device that has an output device connected to it for outputting the context. According to an embodiment, the communication device includes a context device with a context responsive translator and an output device connected to it.

Further in accordance with an embodiment, the context device includes an input device for user identification of the context. In some embodiments, the context responsive translator includes a translation list for selecting translation. In some embodiments, the translation list includes context dependent translations and independent translations. An independent translation is a translation that was derived without accounting for the context. According to an embodiment, the output device includes a display for outputting a context dependent translation.

In a preferred embodiment, the output device includes a haptic device. According to an embodiment, the haptic device provides vibrotactile feedback. According to an embodiment, the output device includes an LED. According to an embodiment, the communication device includes a gesture recognition glove. According to an embodiment, the communication device includes a preset. According to an embodiment, the preset is modifiable.

In some embodiments, the preset is modified in response to a change in context. According to an embodiment, the communication device includes a gesture recognition glove that has a context device and a context responsive translator connected to it. Further in accordance with an embodiment, the gesture recognition glove has a preset connected to the finger portion of the glove and an output device directly connected to the gesture recognition glove.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is an illustration of a communication device according to an embodiment;

FIG. 2 is an illustration of a communication device/gesture recognition glove according to another embodiment;

FIG. 3 is an illustration of a communication device/gesture recognition glove according to another embodiment;

FIG. 4 is an illustration of a communication device/gesture recognition glove according to another embodiment;

FIG. 5 is an illustration of a communication device/gesture recognition glove according to another embodiment;

FIG. 6 is an illustration of a communication device/gesture recognition glove according to another embodiment;

FIG. 7 is an illustration of a communication device/gesture recognition glove according to an embodiment;

FIG. 8 is a perspective view of a three-dimensional zone of movement for a communication device/gesture recognition glove according to an embodiment;

FIG. 9 is an illustration of a three-dimensional zone of movement of a single communication device/gesture recognition glove according to an embodiment;

FIG. 10 is an illustration of a three-dimensional zone of movement of two communication devices/gesture recognition gloves according to an embodiment;

FIG. 11 is an illustration of movement axis's of movement of the zone of a communication device/gesture recognition glove according to an embodiment;

FIG. 12 is method of converting sign language to audible words according to an embodiment;

FIG. 13 is a communication device/gesture recognition glove according to different embodiments;

FIG. 14 is a communication device/gesture recognition glove according to different embodiments; and

FIG. 15 is method of converting sign language to audible words according to another embodiment.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not limit the scope of the present invention.

Example embodiments are described with reference to the accompanying figures, like reference numerals being used for like parts. These figures are not to scale and may not precisely reflect the precise structural or performance characteristics of any given embodiment, and should not be interpreted as defining or limiting the range values or properties encompassed by example embodiments. For example, the size, positioning and spacing of the presets may be reduced or exaggerated for clarity.

When an element is referred to as being “connected” or “coup led” to another element, it can be directly connected or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items. Distinguishing terms such as “first”, “second”, “ top,” or “ bottom” may be used herein to describe various elements. These terms are only used to distinguish one element from another, and should not be interpreted as limiting the element. Thus, a first element could be termed a second element without departing from the teachings of the example embodiments.

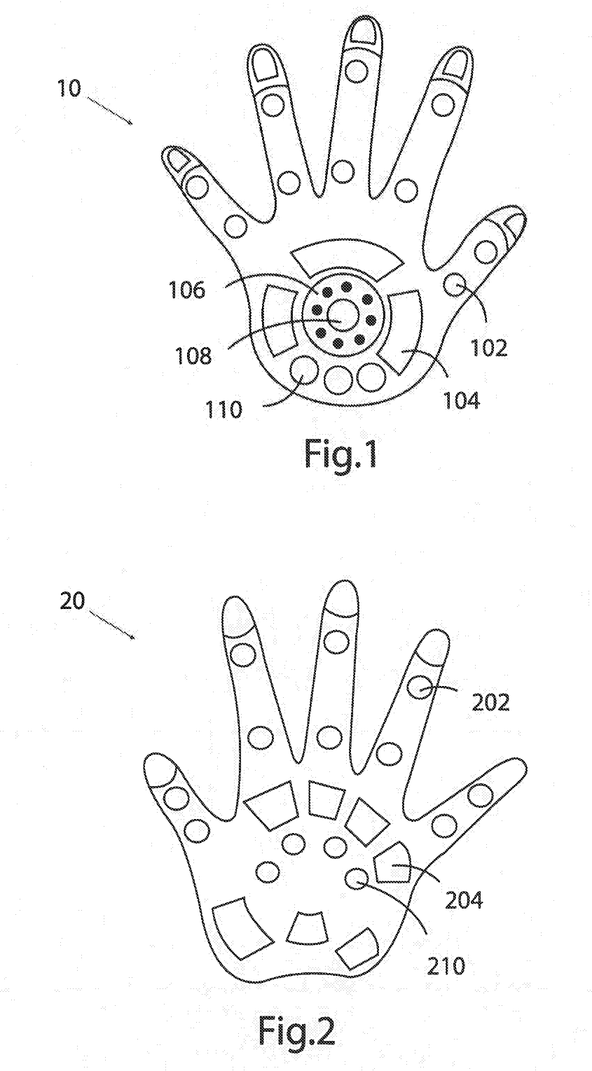

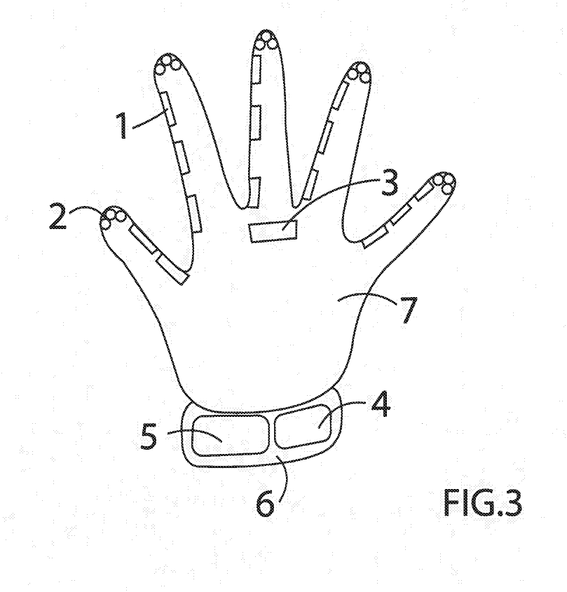

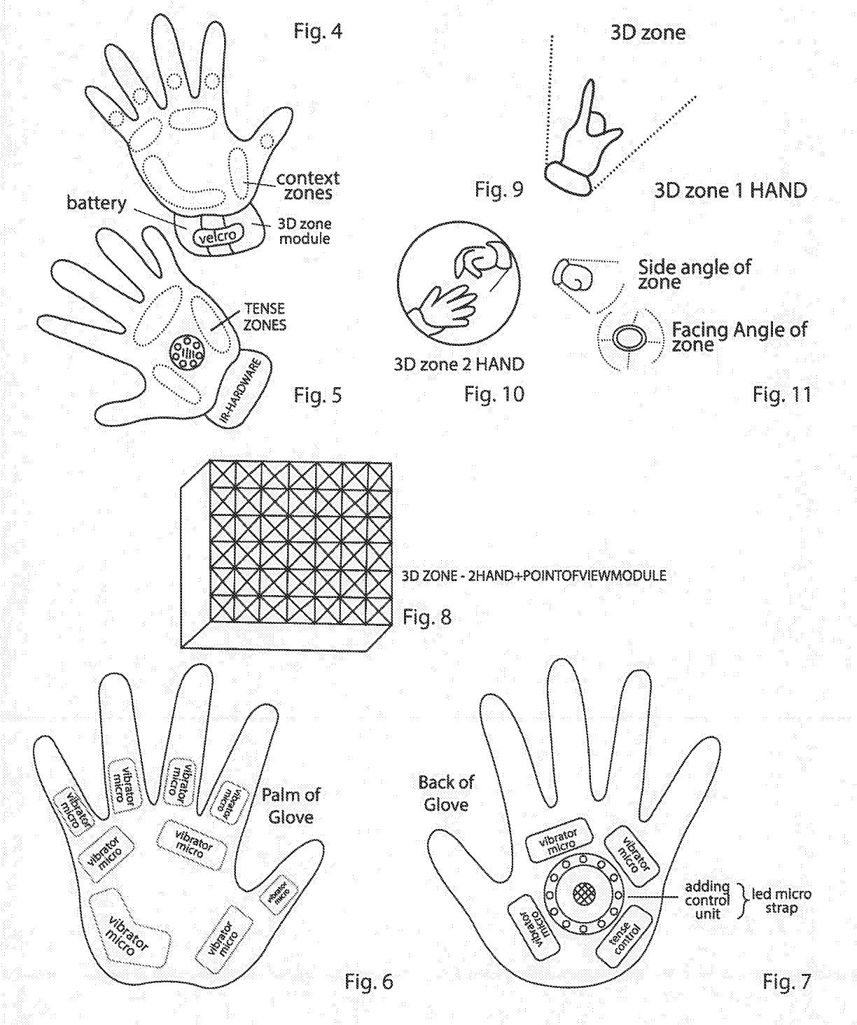

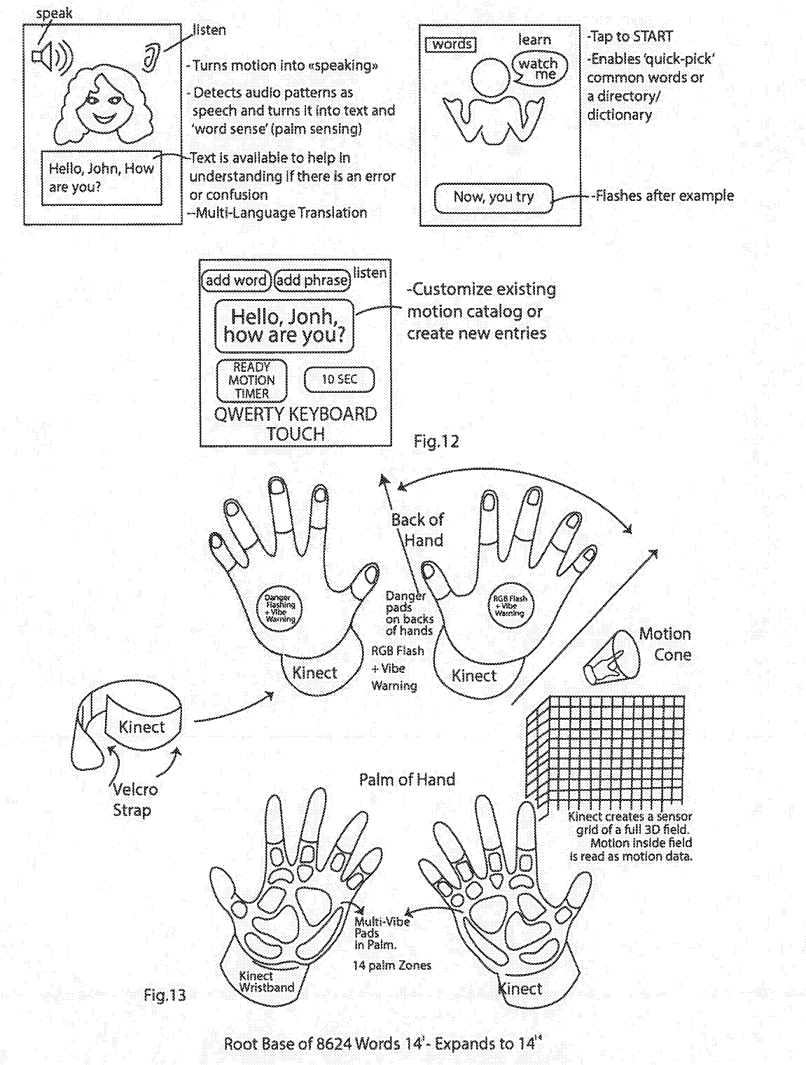

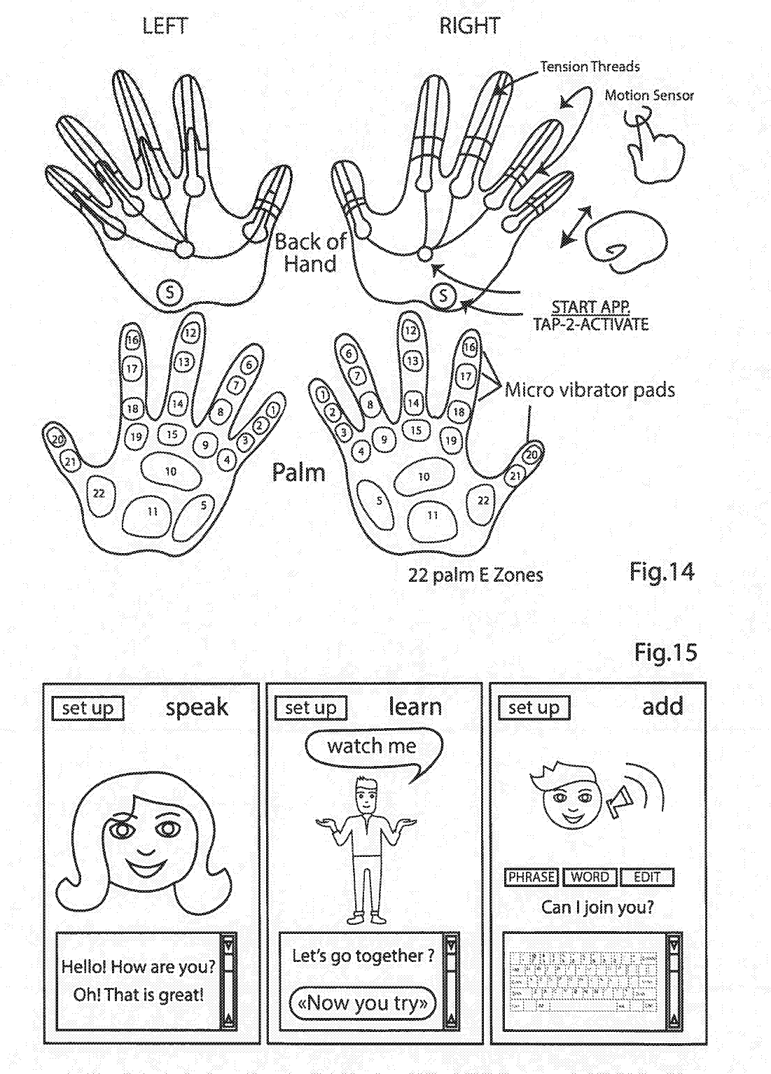

Referring now to the drawing, FIG. 1 shows an illustrative embodiment of an improved communication device. Communication device 10 includes a gesture recognition glove. The gesture recognition glove contains a number of sensors (not shown) that are used to detect and identify the position and movement of the hand. The sensors aid in identifying the gesture and can comprise any suitable sensor or combination of sensors that are suitable to be used in gesture recognition, for example, an accelerometer, gyroscope, flex sensor or other sensor. In this embodiment, a gesture recognition glove is used but any device that is suitable for receiving a pre-translated communication is contemplated, such as a keyboard for receiving text or a microphone for receiving audio.

Communication device 10 also includes a preset 102 that is connected to the gesture recognition glove. In this illustrative embodiment, there are two presets 102 that are located along each finger portion of the gesture recognition glove. Preset 102 can include any suitable input device or combination of input devices, for example, a touchpad, a button or other input device. The number and spacing of presets 102 may vary and may differ from finger portions. For example, the thumb and index portion may have one preset 102 and the rest may have two presets 102 on each finger. In addition, the presets 102 may have the same or different type of function when selected. For example, the presets 102 located on the thumb portion may each activate a different command or program on the gesture recognition glove or on a secondary device (not shown), such as a mobile phone. A preset 102 located on the index portion may change the context and another preset 102 located on the index portion may activate a stored phrase or phonetic.

In this illustrative embodiment, the preset 102 is located on the finger portion of the glove, but other locations are contemplated. For example, a first preset 102 may be located on the palm portion of the glove and a second preset 102 can be located on the finger portion or located on a secondary device. Communication device 10 further includes output devices (104, 106, 108). Any suitable output device can be used, for example, a speaker or a display. In this embodiment, output devices (104, 106, 108) are directly connected to communication device 10, but alternatively any number of output devices may e located on a secondary device that is connected to communication device 10.

In this illustrative embodiment, communication device 10 includes haptic device 104. Haptic device 104 conveys context by applying vibrations, but other methods are contemplated such as applying pressure or a change in temperature. As an example, the context may be conveyed by the application of different vibrations that correspond to a participant's emotional state. Differences in vibrations can include, but is not limited to, vibrations that have different locations, intensities or frequencies. For instance, an angry emotional state may be indicated by an intense vibration and an excited emotional state can be indicated by a pulsed vibration.

Communication device 10 includes LED 106. LED 106 is similar to that known in the art. It can be organic or inorganic, and can be any color or combination of colors. In this illustrative embodiment, there are a number of LEDs 106 located on the back of the hand in a circular pattern, but any location and pattern is contemplated. For example, a plurality of LED 106 could be in a linear pattern along each finger and each finger may have the same or different color and number of LEDs 106. The LED can output the context by switching on/off or changing in color, intensity or blinking frequency.

In this illustrative embodiment, communication device 10 further includes speaker 108 that can be used to output a translated gesture. As an example, the gesture recognition glove can aid a hearing-impaired person by recognizing and translating the different signs into audio.

Communication device 10 further includes selection device 110. In this illustrative embodiment selection device 110 is a touchpad, but it may comprise any input device, such as a button or a touch screen. Selection device 110 can be used to switch between functions, activate programs or used as a pointing device. In this illustrative embodiment, there are three selection devices 110 that are located near the wrist portion of the glove. The location of the selection device 110 can be varied and can also be located on a secondary device.

Communication device 10 also includes a context device (not shown). The context device (not shown) can be used to identify the context surrounding a communication. A context device (not shown) can include, for example, GPS, an electronic calendaring system, a camera, a mic, facial recognition software, audio analysis software, heart rate monitor, an input device, an RFID, a Near Field Communication device, a database of faces, or a database containing specific details. As an example, context device (not shown) can include a mic and audio analysis software for identifying a participant's emotional state. Performing a stress analysis on the audio, the context device (not shown) could identify a participant's emotional state, such as anger or excitement. A context device (not shown) could also include a camera, a database of faces and facial recognition software for recognizing specific participant. The specific participant's relationship status and other specific details could then be used to identify the context.

Communication device 10 also includes a context responsive translator (not shown). The context responsive translator (not shown) can include a database containing translations, such as signs for American Sign Language. The identified gestures could be compared with the database and a context dependent translation can be selected based, at least in part, on the identified context.

For example, a hearing-impaired person could identify the context, such as an angry emotional state, from a drop down menu on the context device (not shown) or selecting a preset 102 that is located on the gesture recognition glove. Afterwards, the user could input a pre-translated communication, a signed gesture, into the communication device 10 by using the gesture recognition love. The signed gesture would then be translated by the context responsive translator (not shown). The context dependent translation, a computer voice with an emotional element, an angry voice, could be outputted to output device 108, a speaker.

As another example, communication device 10 could identify a speaker's anger using a microphone and voice analysis software. The identified context could then be conveyed to a hearing impaired person through vibrotactile feedback. The vibrotactile feedback could allow the user to verify the context prior to a translated response being outputted by the speaker.

Communication device 20, an illustrative embodiment, is depicted in FIG. 2. In this embodiment, preset 202 is a touchpad located on the opposite side of the glove, the palm. Communication device 20 further includes seven haptic devices 204 and is patterned to cover a larger area. This illustrative embodiment also includes selection device 210 that is located on the palm portion of the glove.

Various modifications may be made to the described embodiments without departing from the spirit and scope of the invention. Features shown in each of the implementations may be used in dependently or in combination with one another. For example, haptic devices may be located on the back of the hand and on the palm.

In another embodiment, users may wear gloves with the primary tech built into the cuff/wrist. The tech in both gloves combines to define a 3D zone in which hand motion is detected. This motion is sign-language that is the translated into speech audio. As the user signs an app on their mobile device translates the movement into word-speak which is played through the mobile devices speaker.

User's mobile device also operates as a listening device. When someone speaks to the user the mobile device converts the words into “sensory date” that the wearer/user experiences thru the gloves sensory zones. Thru these two methods a user can carry on a full conversation in sign-language with someone who doesn't sign.

In one embodiment, the gloves are made of a light breathable material. There are one micro-vibrator in each finger and thumb, like those in a cellphone. The palm has five micro-vibrators. On the back of the hand there are three micro-vibrators surrounding a circular badge. The badge has five RGB-LED (miniaturized), and a micro-speaker with a piercing tone alert. In one aspect, on the palm of the glove the Vibrators are “context” zones, like a combination of Morse code and phonetics. The pulse patterns spell out words for the user. There are a total of 20 context libraries to help speed up or simplify their translation.

In one aspect, on the back of the hand on the glove the vibrators are used to determine “tense” of the speaker's voice. There are a total of 6 tense zones which produce 6 patterns used to define tone and stress patterns to combine with the context zones. This will allow the user to understand the speech as well as emotion of the speaker. In one aspect, the badge may include LED lights flash brightly and the tense zones vibrate if the mobile app detects any one of the “alert” sounds: Key words such as “HELP!!”, “LOOK OUT!”, or “RUN!”. It will also activate if it detects the sound of a car-horn, screeching brakes, the sound of a barking or growling dog. In the event the user assigns a “safe word”, activating it will set off the flashing LED's and the piercing alert tone. The ability to know a potential hazard, danger, or to get the attention of people in case of an emergency is the whole purpose of this utility.

In one embodiment, power may be provided to each glove by a battery that sits in the cuff/wrist. It is the same battery used for cellphones. It USB rechargeable using a USB dongle. In one embodiment, the present invention may include a mobile device as described herein. For example, there may be two versions of the application that is run on a mobile device or computing device. One is for a tablet/pad/laptop/pc. The other is for a smartphone. The first version is used to setup custom settings and for training the user in signing with the gloves.

In one embodiment, the present invention includes voicing capabilities. The user creates a unique “voice” in a step-by-step process. It starts with the user's age and gender. Following that the user picks their language, even selecting from dialects if there are any available. Dialect affects the way a word is actually announced. It adds an individual characteristic.

The next step would be to identify the user's actual voice-pitch. A utility listens while the user announces “ahh”, “oh” and “eee”. It then identifies the key and octave of the user. The utility uses this pitch as the audio of the voicing. In this way a voicing is closely matched to the individual user.

In another embodiment, the present invention may include a quick-sign feature. The user can create a library of word-speak which is associated with a brief gesture. Each library can be up to 50 words that are activated by this sign gesture. A series of Quick-Signs can be used to give a speech or tell a story, introduce ideas—whatever the user decides.

In yet another embodiment, the user's voicing has a capacity for ‘tense’, a deviation in the audio which can be used to sound excited, upset, sad, melancholy, happy, bouncy, tired, and normal. Moving into a ‘tense’ is a matter of a motion key. This allows the user to communicate emotion.

In still yet another embodiment, the present invention may include a singsong feature. The user's voicing has the capacity to allow the user to sing. A utility lets the user declare the key scale of the song. For example: A song in B (B flat) has the basic chords B—E and F. B has the relative minor chords G minor, C minor and D7. In Singsong mode the user can move through the key-scale by describing the melody, and voice (tenor, soprano, alto-bass, baritone, messo soprano, falsetto). The user defines the beat, such as 4:4. Then the user can select effects such as chorus, echo, harmonizer, etc. Auto-tune and pitch control help the voicing match the music when it plays. The user signing becomes a user singing.

Additionally, the present invention may include a dance feature. Either with the singsong utility or as a stand-alone. The utility detects drum and bass, delivering pentameter to one hand. It detects melody and other instrumentation, delivering it to the other hand. Using the context zones the user experiences the beat and the riffs and the melody along with the words of the song. In this way the user can experience live music and DJ mixes in real-time.

Also, the present invention may include an airband feature. The user can pick an instrument from a library. Each hand becomes an aspect of the instrument which the wearer experiences in the same as singsong and dance enable interaction. Note scales move up and down based on defined hand positions. Flair and nuances are affected by finger motion. Drum and bass can be dedicated to a hand or a few fingers. Example: The thumb is the activator. Tapping the thumb and index will produce a kick-drum. Middle finger might be a snare or high hat. Pinky could be a symbol. On the other hand guitar chords could spread across fingers which tap the thumb to activate. Effects and switching between them can be preset gesture. As part of the whole the user can produce their own jam, or follow along with someone else's.

Additionally, the present invention may include a heads up display (HUD). Users can add a HUD utility/device to stream text translations through a non-invasive display. HUDGlasses, Smartlenses, ARGlasses—all can be used to receive the text that the app is also turning into ‘context’ data for gloves and sign being translated from the user. This allows for broader use of the Re-Voice for people having trouble or wanting to enhance their use of the gloves.

In another aspect, the present invention may include presenting translation. The user's mobile application has the ability to display text in real time. This lets both the user and the speaker work out context and translation errors in the event one or both have misunderstood a word or phrasing. The user can setup a Quick-Key to start recording a conversation to text file, complete with ‘tense’ and text.

In one embodiment, the smartphone or mobile device is setup with the mobile device application as the parent. All configurations and libraries are stored on the parent. The parent pushes settings to the smartphone, including voicings. Both devices can be used together, or separately. All features may not be available on the smartphone.

Additionally, the present invention may include add-ons. The user can add wireless speakers, 3D zone modules, languages and group features. The application can translate sign into any published language. The user has their initial language already. Upgrades adds one language per upgrade with no maximum other then what is available.

Three-dimensional (3D) capability is also part of the present invention. Components can be added wirelessly to create a wider and clearer detection field for user to sign. As are group features. Other users connect wirelessly to play custom games, share singsong, airband or dance experiences, or chat.

Another feature of the present invention is call-sign. This feature lets the user receive cellphone calls and ‘talk’ using the gloves to communicate in the same way as any other conversation. The exception is that the user never has to actually touch their smartphone to make or receive calls. Tense zone pulses communicate when the phone is receiving a call. Caller ID can use context zones to announce caller before answering the phone. A gesture can answer it, or send it to voicemail, or deny the call. A voicemail can be received in the same context.

In one aspect, the present invention may provide the unique personal voice modeled on the user's vocal pitch where possible. In another aspect, the present invention may provide the ability to speak any language, or all of them. In yet another aspect, the present invention may provide the ability to use a cellphone as a phone and not a texting tool. Additionally, the present invention may include the ability to detect nuances in speech. Also, the present invention may include the ability to create custom sign motions, words, and phrasing.

In still yet another aspect, the present invention may include the ability to ‘hear’ music, to sing and dance. It may also provide the ability to turn gestures into instrumentation and play along with others.

The present invention is a total solution package, combing wearable hardware and a mobile app. The gloves are the core of the present invention. They are intended to be form fitting, made of fabric that is popular in sports for its ability to wick away sweat, and anti-microbial. So, it doesn't wind up being something that has to be taken off often. Since the gloves have actual electronics installed, special case in cleaning is required. But, performed easily with a custom cleaning kit that includes a soft brush and a spritzer spray bottle.

Additionally, the technology in the gloves is used to capture hand motion, position, and to provide tactile feedback to the wearer. Palm and finger tips have rubber pads to allow the wearer to pick-up, and hold objects, even small ones. Flexibility sensors, motion sensors, and proximity sensors combine with tiny vibrators installed in convenient positions to maximize effect. Hand-speak is detected using motion and flex sensors, and converted to (serial) data. These are “input devices”. The micro-vibrators in the glove are “output devices” which serve to accent audio data being received by the application. The glove is powered by a rechargeable battery anticipated to last several hours.

The present invention mobile application is the workhouse in one instance. Its main functions are to translate the hand-speak input data into audio output for the benefit of the listener; and to translate audio input into display text, and context, using smart glasses and the gloves output modules. It will offer tools to create authentic voicings, or a template to create custom voicings based on configurable variables. (age, sex, ethnicity, nationality) It will be able to detect voice stressors and variables such as volume, pitch, tersity, and communicate this as “context data.” Each word has a phonetic form. The app will communicate the audio input's phonetic form using the micro-vibrators installed on the glove. This, paired with the glasses, will reinforce the wearable comprehension, speed in understanding, and with experience—reduce dependency on the glasses.

In one embodiment, the present invention may be incorporated into one glove. In another embodiment, the present invention may be incorporated into two gloves. Additionally, all processing of signals may occur on the glove itself without any further need for an external mobile device or computing device. In yet another embodiment, one or more gloves may be in wired or wireless communication with the external mobile device or computing device. If it is in wireless communication with a mobile device or computing device, such wireless communication may be done by those known to those skilled in the art, such as Bluetooth.

While this invention has been described with reference to illustrative embodiments, this description is not intended to be construed in a limiting sense. Various modifications and combinations of the illustrative embodiments as well as other embodiments of the invention will be apparent to persons skilled in the art upon reference to the description. It is, therefore, intended that the appended claims encompass any such modifications or embodiments.

What is claimed is:

1. A device for converting sign language to audible words, comprising:
one or more gloves having one or more sensors disposed about the fingers of the one or more gloves for detecting finger positions of sign language of a wearer of the one or more gloves;
a processor for converting the detected sign language to the audible words;
a memory unit for storing a library of the sign languages in communication with the processor;
a power unit for powering the device; and
a speaker for sounding the audible words.

2. The device for converting sign language of claim 1, further comprising:
an input/output unit for transmitting the detected sign language to an external mobile device or computing device.

3. The device for converting sign language of claim 2, wherein the mode of transmission is wired.

4. The device for converting sign language of claim 2, wherein the mode of transmission is wireless.

5. A system for converting sign language to audible words, comprising:
one or more gesture recognition gloves comprising:
one or more sensors disposed about the fingers of the one or more gesture recognition gloves for detecting finger positions of sign language of a wearer of the one or more gesture recognition gloves;
a processor for converting the detected sign language to the audible words;
a memory unit for storing a library of the sign languages in communication with the processor;
a power unit for powering the device;
a speaker for sounding the audible words; and
a transceiver for transmitting the detected sign language to an external mobile device or computing device.

6. The system for converting sign language to audible words of claim 5, wherein the communication link is wired.

7. The system for system for converting sign language to audible words of claim 5, wherein the communication link is wireless.

8. A method for providing apparatuses for converting sign language to audible words to hearing-impaired users, the method comprising:
accepting funds from individuals;
purchasing the apparatuses; and
donating the apparatuses to the hearing-impared users.
